(19) United States
(12) Patent Application Publication
(10) Pub. No.: US 2019/0150422 A1
(43) Pub. Date: May 23, 2019

(54) Skeeter EaterTM Apparatus and Method for Concentrating then Killing Mosquitos

(71) Applicant: Gerry M. Welch, Cooperstown, NY (US)

(72) Inventor: Gerry M. Welch, Cooperstown, NY (US)

(21) Appl. No.: 16/260,045

(22) Filed: Jan. 28, 2019

(30) Foreign Application Priority Data
Jun. 4, 2018 (US) PCT/US18/35875

(51) Int. Cl. A01M 1/02; A01M 1/10

(52) U.S. Cl. CPC A01M 1/02; A01M 2200/012; A01M 1/106

(57) ABSTRACT

An apparatus and related method for concentrating then killing mosquitos, comprising: a mosquito larvae trap for containing a stagnant, stationary pool of water for luring female mosquitos; a mosquito trapping screen in the shape of an inverted funnel comprising a fine mesh of apertures small enough to prevent mosquitos from passing therethrough, and comprising at least one female entry hole proximate its lower center inverted apex which female entry hole is large enough to allow passage by female mosquitos; the mosquito trapping screen entirely covering a top portion of the mosquito larvae trap to bar entry to the stagnant, stationary pool of water other than by passing through the female entry hole; the mosquito larvae trap further comprising a light-transparent section over at least a substantial portion of its upper perimeter.

### CROSS-REFERENCE TO RELATED APPLICATIONS

This application claims priority benefit from international application PCT/US18/35875 filed Jun. 4, 2018.

### BACKGROUND OF THE INVENTION

According to the American Mosquito Control Association, “Mosquitoes cause more human suffering than any other organism—over one million people worldwide die from mosquito-borne diseases every year. Not only can mosquitoes carry diseases that afflict humans, they also transmit several diseases and parasites that dogs and horses are very susceptible to. These include dog heartworm, West Nile virus (WNV) and Eastern equine encephalitis (EEE). In addition, mosquito bites can cause severe skin irritation through an allergic reaction to the mosquito's saliva—this is what causes the red bump and itching. Mosquito vectored diseases include protozoan diseases, i.e., malaria, filarial diseases such as dog heartworm, and viruses such as dengue, encephalitis and yellow fever.” (http://www.mosquito.org/mosquito-borne-diseases).

It would be desirable to have a device and method to very substantially control and mitigate the health risk of mosquitos both in the Unites States and worldwide.

### SUMMARY OF THE INVENTION

Disclosed herein is an apparatus and related method for concentrating then killing mosquitos, comprising: a mosquito larvae trap for containing a stagnant, stationary pool of water for luring female mosquitos; a mosquito trapping screen in the shape of an inverted funnel comprising a fine mesh of apertures small enough to prevent mosquitos from passing therethrough, and comprising at least one female entry hole proximate its lower center inverted apex which female entry hole is large enough to allow passage by female mosquitos; the mosquito trapping screen entirely covering a top portion of the mosquito larvae trap to bar entry to the stagnant, stationary pool of water other than by passing through the female entry hole; the mosquito larvae trap further comprising a light-transparent section over at least a substantial portion of its upper perimeter; wherein: female mosquitos lured to the stagnant, stationary pool of water can gain entry thereto through the female entry hole; and baby mosquitos hatched from eggs laid by female mosquitos in the stagnant, stationary pool of water, lured by ambient light passing through the light-transparent section of the perimeter of the mosquito larvae trap, and also attempting to fly upwards, are unable to escape and thereby remain trapped beneath the outer upper circumferential section of the screen until they die.

### BRIEF DESCRIPTION OF THE DRAWINGS

The features of the invention believed to be novel are set forth in the appended claims. The invention, however, together with further objects and advantages thereof, may best be understood by reference to the following description taken in conjunction with the accompanying drawing(s) summarized below.

FIG. 1 illustrates both a top plan and side cross-sectional view of a first preferred embodiment of the invention which electrocutes mosquitos by passing an electrical current through a stagnant, stationary pool of water to which they are lured.

FIG. 2 illustrates a side cross-sectional view of a second preferred embodiment of the invention which electrocutes mosquitos by using the stagnant, stationary pool of water to lure mosquitos to pair of electrified grids, and also illustrates a top plan view of the electrified grids.

FIG. 3 illustrates both a top plan and side cross-sectional view of a third preferred embodiment of the invention which kills mosquitos using ultraviolet irradiation.

FIG. 4 illustrates a top plan view of a fourth preferred embodiment of the invention which traps and kills mosquitos using a specially-designed mosquito trapping screen, and also illustrates a side cross-sectional view of the mosquito trapping screen.

FIG. 5 illustrates both a top plan and side cross-sectional view of a fifth preferred embodiment of the invention which traps and kills mosquitos using suitable poisons.

FIG. 6 illustrates a top plan view of a sixth preferred embodiment of the invention which traps and kills mosquitos using a specially-designed mosquito trapping screen with a funnel profile, and also illustrates a side cross-sectional view of this funnel-profile mosquito trapping screen.

### DETAILED DESCRIPTION

It is well known that mosquitos breed in stagnant standing water. To take advantage of this natural fact, the invention purposefully creates a localized breeding area for mosquitos to deposit their eggs for hatching into larvae, coupled with a mechanism for killing the larvae before maturity at pre-selected time intervals and/or at will and/or based on mosquito activity. The mosquito kill mechanisms in various embodiments of the invention include electrocution, ultraviolet irradiation, baby mosquito trapping, and poisoning, as will be further detailed below.

By optimizing the environment for growth such that it is particularly attractive to mosquitos, mosquitos in the nearby area will be drawn to deposit their eggs in the trap rather than at other nearby locales, so that the vast majority of hatched larvae will be bred in a place where they may be destroyed before they mature. The period for maturity may be as short as 4 days and as long as 14 days or more, depending on the type of mosquito and various environmental factors.

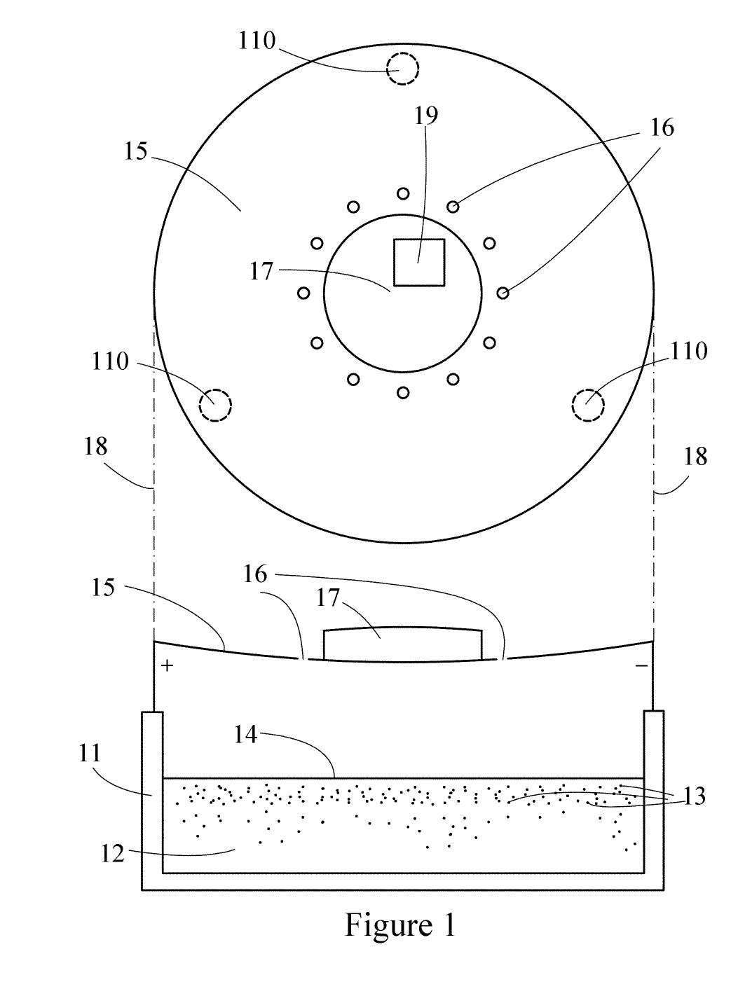

FIG. 1 illustrates the invention in a first preferred embodiment, from both a plan top and side cross-sectional view interrelated by the illustrated projection lines 18. A larvae trap 11 comprises a simple pan-like enclosure of any desired shape and size so long as it is capable of containing a stagnant stationary pool of water 12 which is intended to naturally stagnate, as illustrated. Female mosquitos will be lured to deposit their eggs in this trap 11 and once the eggs have hatched, the larvae 13 will tend to accumulate near the top surface 14 of the stagnant water 12.

Situated above the trap 11 is a water collector and debris shield 15, preferably concave when viewed from above, for preventing falling leaves, plants, branches, etc. from landing in the trap, and also for collecting rainwater and funneling it into the trap 11 via a plurality of water apertures 16 also as illustrated from both the top and side plan views. This collection of rainwater replaces any water that otherwise evaporates and ensures that the trap 11 always contains water 12 without the user having to constantly refill the trap 11. This also provides a place for leaves to decay and water containing the decay matter to pass through the water apertures 16 into the trap 11 and contribute to the stagnation in the pool 12. The water apertures 16 are optimally sized so as to avoid clogging when leaves have accumulated, and to allow the water to seep therethrough regardless. Although the projections 18 of FIG. 1 illustrate the water collector and debris shield 15 to have similar diameter to the trap 11, it may be desirable to have the water collector and debris shield 15 comprise a larger diameter so as to increase the surface area over which rainwater may be collected and routed into the trap 11.

The water collector and debris shield 15 should elevated above the trap 11 with spacing provided along the perimeter to allow mosquitos to gain access to the trap 11, and or to control the passage of light as will be discussed for the specific different embodiments. In FIG. 1, strictly for illustration and without any implied limitation, three shield supports 110 are illustrated so as to schematically indicate a tripod of contact points that elevate the water collector and debris shield 15 above the top surface of the trap 11. There may be any number of such support within the scope of this disclosure and the associated claims, and they can be of any forms, e.g., posts, stable rigid screening, and equivalents.

A power source 17 is conveniently situated atop the center of the water collector and debris shield 15, and is electrically-connected to the trap 11 in such a way as to deliver a voltage into the water 12 so that any larvae 13 living in the trap 11 at the tie will be electrocuted. The positive (+) and negative (−) terminals of the voltage are also illustrated. While FIG. 1 illustrates the power source 17 atop the water collector and debris shield 15, this location is exemplary, not limiting. Any location that is convenient for the power source 17 is regarded to be within the scope of this disclosure and the associated claims. The power source 17 likewise can take any form that is known or may become known in the art, including but not limited to batteries, fuel cells, solar power generators, wind generators, small motors, household currents, and equivalent devices and methods. Also, combination of these aforementioned may be used. For example, power source 17 may comprise a solar collector thereof, used to charge and recharge a battery thereof.

Finally, it is well known how to introduce an electric current into a pool of water, and any means for doing so is also encompassed by this disclosure and its claims. All that is required is to have an electrical connection for enabling a power source 17 attached to said electrical connection, to introduce an electrical current into said stagnant, stationary pool of water 12, with a voltage sufficient to electrocute mosquito larvae 13 in said stagnant, stationary pool of water 12.

Although the trap 11 and the water collector and debris shield 15 are illustrated to be circular from the top view, the shape of these components is irrelevant to the functioning of the invention, and any desirable shape is regarded to be within the scope of this disclosure and the claims. This includes recognition that various artistic shapes may be desired so that the trap and its components blend into the environment in a visually appealing manner. The shield 15 also serves to prevent animals and children from contact from the electrified elements and the water pool.

The voltage to kill the larvae 13 may be activated by the user, at will. Alternatively, or in addition, the power source 17 may be equipped with a schematically-illustrated timer 19 that will zap the stagnant water pool 12 with electrical charge before breeding cycle is complete, killing the mosquito larvae 13. In this way, the trap 11 resets itself and will work continually for extended periods of time. Additionally, the decayed larvae 13 will help to attract the next generation of mosquitos to deposit their eggs in the trap 11. The power source 17 combined with a heating element (not shown) may also use excess electricity to slightly warm the pool of water 12 adding to the water stagnation.

The bottom of the trap 11 may optionally comprise an attached pointed stake or equivalent footing(s) (not shown) for securing the trap 11 to the ground. The manufactured color(s) of the trap 11 can vary from black to lighter colors depending on climate/environment. Darker colors in cooler environments are helpful to warm the water 12 to aid in stagnation, while lighter colors in warner environments are helpful to reduce the rate of evaporation.

Optionally, more advanced versions can be equipped with water reservoirs interconnected with the trap 11 to maintain a constant water level 14 in the trap 11. Additives can be added to the water 11 as an attractant to mosquitos to draw the local mosquito population to lay their eggs in the trap, and/or as an aid in stagnating the water.

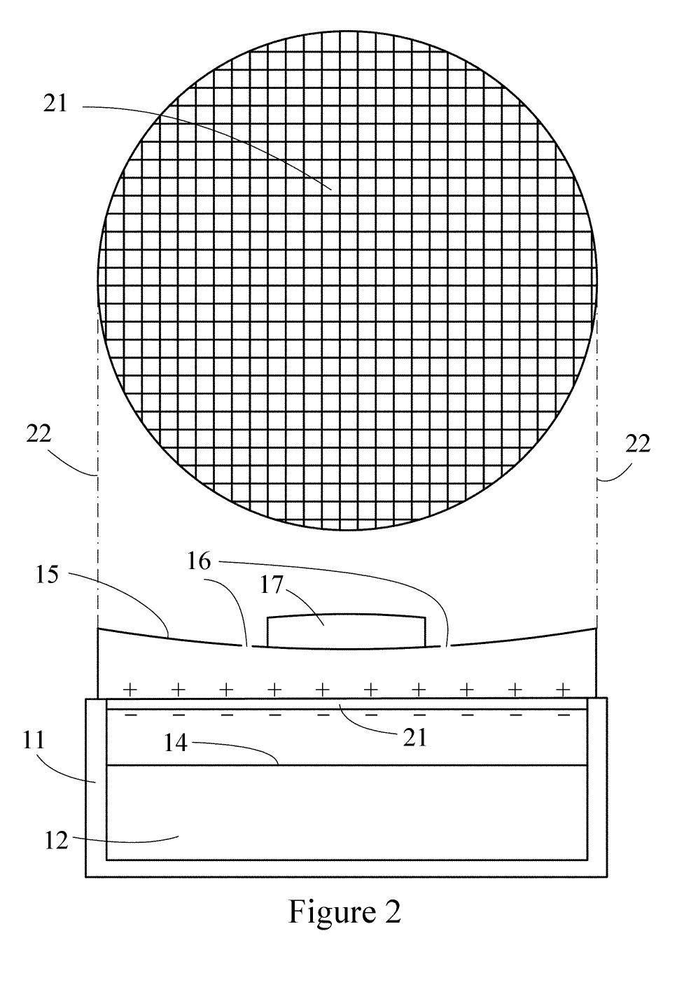

FIG. 2 illustrates a second preferred embodiment which likewise uses electrocution for killing mosquitos. However, in contrast to FIG. 1, the stagnant stationary pool of water 12 is not used to breed and hatch larvae, but rather is used as a lure to draw female mosquitos to a pair of electrified grids 21 (e.g., wire mesh) with an applied voltage between the two grids, in the manner of the electrified “bug zappers” which are known and commonly-used in the art. These typically employ a transformer or the like to generate a voltage drop (often, and without limitation, of 2000 V or more), as is illustrated by the + and—charges shown to have accumulated on each of the grids in the grid pair 21. As illustrated in the side view in FIG. 2, the pair of electrified grids 21 is situated over the water pool 12 but below the water collector and debris shield 15.

Now, in the prior art, light is used to lure bugs toward zappers. In this embodiment of the present invention, it is the stagnant stationary pool of water 12 which is used as the lure. Specifically, female mosquitos seeking to breed will instinctively detect the presence of, and be attracted to, the stagnant stationary pool of water 12 and be drawn toward that pool. But, while flying toward the water pool 12 after crossing the perimeter spacing, they will encounter the pair of electrified grids 21 blocking their access to the pool 12. So, when they reach the electrified grids 21 their bodies will complete the circuit across the voltage drop and they will be electrocuted.

The embodiment of FIG. 2 continues to utilize the water collector and debris shield 15 with the plurality of water apertures 16 reviewed in FIG. 1, for the same reasons, as shown in the side view. In this embodiment, this should be elevated sufficiently above the top of the trap 11 to permit mosquitos to enter and come into contact with the electrified grids 21, yet small enough to deter small children or animals from contacting the grids 21. It also continues to utilize a power source 17, but here, this power is used to create the voltage across the pair of electrified grids 21 rather than within the water pool 12. The water collector and debris shield 15 is not shown in the top view of FIG. 2; rather what is shown is the pair of electrified grids 21 which sit below the water collector and debris shield 15 and above the water pool 12 in a position that block access to the pool 12. That is, these grids 21 entirely cover a top portion of the mosquito larvae trap 11 to bar entry to the stagnant, stationary pool of water 12 other than by passing through the pair of electrified grids 21. The optional timer 19 which was illustrated in FIG. 1, is not at all needed in the FIG. 2 embodiment. This is because bug zappers are dormant until a bug arrives to complete the circuit across the voltage. So, the arrival of a mosquito itself, effectively operates as the “timer.”

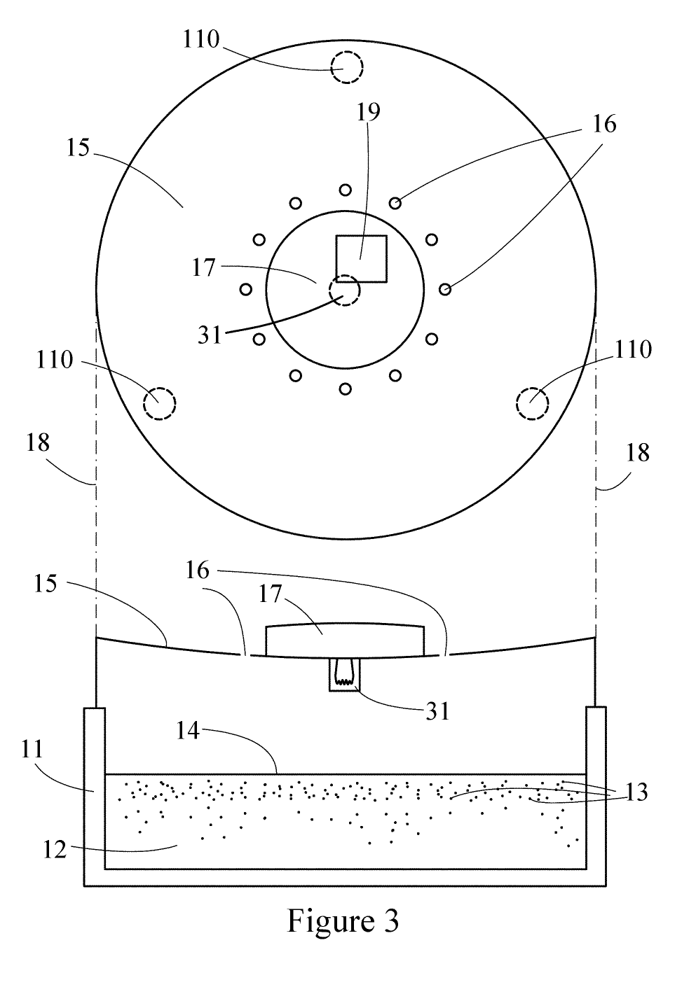

FIG. 3 illustrates a third preferred embodiment of the invention, which uses ultraviolet light to kill mosquitos. In this embodiment, an ultraviolet light source 31 is placed in a position that will deliver ultraviolet light into the stagnant stationary pool of water 12. The power source 17 is now used to power the ultraviolet light 31 rather than to electrocute mosquitos. In all other respects, this is configured just like the embodiment of FIG. 1. Here, however, the female mosquito, and larvae, and any hatched larvae are all killed because ultraviolet radiation will kill small insects that are exposed to it. The timer 19 may be used to turn the light 31 on and off at intervals just as in FIG. 1. The benefit of the timer here, is that if the ultraviolet light is left on all the time, the stagnation needed to draw mosquito to the pool 12 may not occur. By having the light off for some intervals of time, the pool 12 can stagnate. Then when the timer 19 turns on the light for other time intervals, the mosquitos and any larvae will be killed. Less electricity is required, and this is safer for children and animals than the electrocution embodiments. It is preferred that the water collector and debris shield 15 not be transparent to light, so that the ultraviolet light is focused inside the water pool 12.

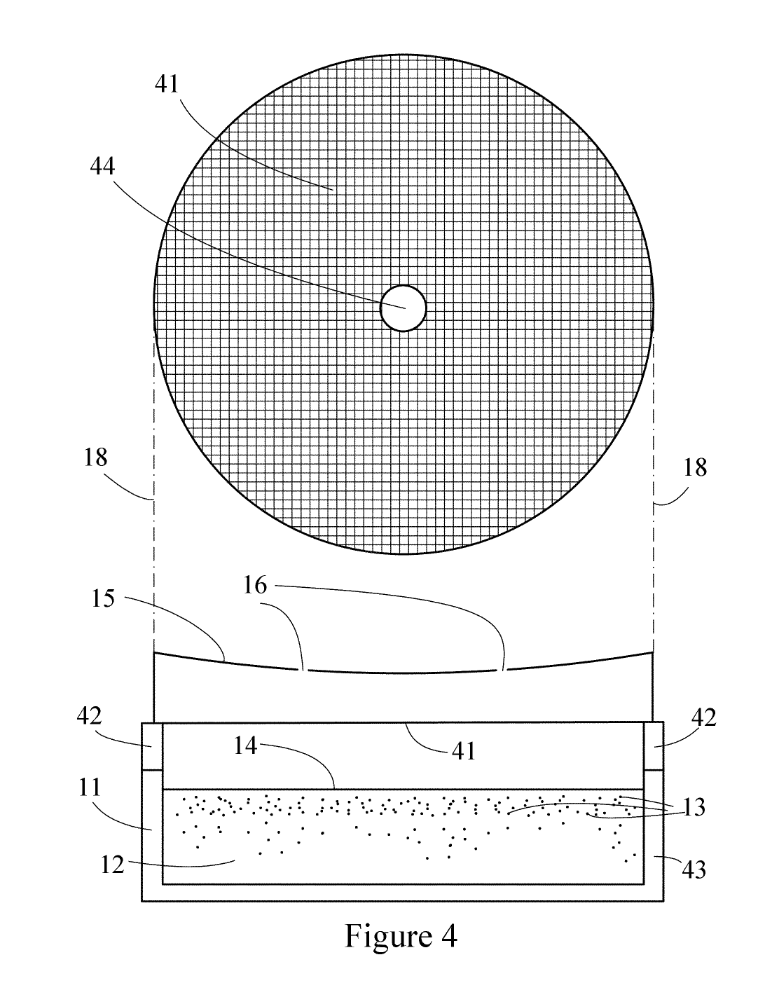

FIG. 4 illustrates a fourth preferred embodiment of the invention, which uses a specially-designed trapping screen 41 to trap mosquitos, wherein the trapping itself operates as the kill mechanism. No electricity is required at all in the embodiment, other than to provide ambient light at night for reasons to be discussed. The configuration of this embodiment is similar to that of FIG. 2 in most respects, except for the replacement of the pair of electrified grids 21 with a single trapping screen 41. This screen 41 contains a fine mesh of apertures similar to what is used for screen windows in homes to allow fresh air to enter a room from outside while blocking the entry of mosquitos and other bugs. It will be noted that the apertures of such window screens are typically 1/16″× 1/16″ square or smaller.

As illustrated by the side view of FIG. 4, this trapping screen 41 is set atop and about the upper outer circumference of the larvae trap 11 such that it is not possible to enter or egress from the water pool 12 without passing through the screen 41. This trapping screen 41 however, also comprises at least one female entry hole 44 proximate its center, which hole 44 is large enough to allow passage by a female mosquito. A preferred diameter for this hole 44, without limitation, is about ¼″. In this embodiment, the larvae trap 11 is configured to comprise a light-transparent section 42 over at least a substantial portion of its upper perimeter. Otherwise, it is not transparent (opaque) in its other, lower sections 43, for reasons which will be monetarily discussed.

In this embodiment, the female is drawn to the stagnant stationary pool of water 12 as in the previous embodiments. However, the only way to enter the water pool 12 is by going through the female entry hole 44. A female mosquito sensing the stagnant water 12 and seeking to breed in that water, will instinctively persist in trying to penetrate the screen 41 until she finally stumbles upon the entry hole 44 and succeeds in passing through the screen 41. After the female lays her eggs, and after the larvae are hatched, the baby mosquitos will leave the water pool 12 and try to escape. However, they will be trapped inside by the screen 41 and unable to escape except via that same female entry hole 44.

This is where the light-transparent section 42 comes into play. Because the baby mosquitos will not have any independent sense of direction, and will move based on being attracted to light, by having the only light be that which is visible through the light-transparent section 42, the mosquitos will be drawn toward the outer perimeter of the screen, and away from the female entry hole 44 proximate the center of the screen 41. This is exactly the region from which they cannot escape. So, over a period of time, these baby mosquitos will simple die because they have no way to exit the trap.

During daylight hours, nothing else is needed. However, at night, there is no light to draw the baby mosquitos away from the female entry hole 44 and toward the outer perimeter of the screen 41. Accordingly, it is desirable to provide a source of nighttime ambient light which will continue during the night to draw the baby mosquitos toward the perimeter of the screen where they will remain trapped. This light may independently provided, or, using a power source 17 as previously discussed, may be made part of the invention device itself. Suitable independent light sources may include, but are not limited to, outdoor solar-spectrum lighting systems. Likewise, a timer 19 or a photoelectric detector that can sense when it is dark and light outside, may be used to trigger and cease the independent provision of ambient light at the appropriate time.

This embodiment also uses the water collector and debris shield 15 with the plurality of water apertures 16 reviewed in FIG. 1, for the same reasons. In this embodiment, however, it is desirable to minimize the elevation of the water collector and debris shield 15 above the trap 11 so to minimize the entry of light from anywhere other than through the light-transparent section 42 and avoid any substantial amount of light from reaching the center proximate the female entry hole 44.

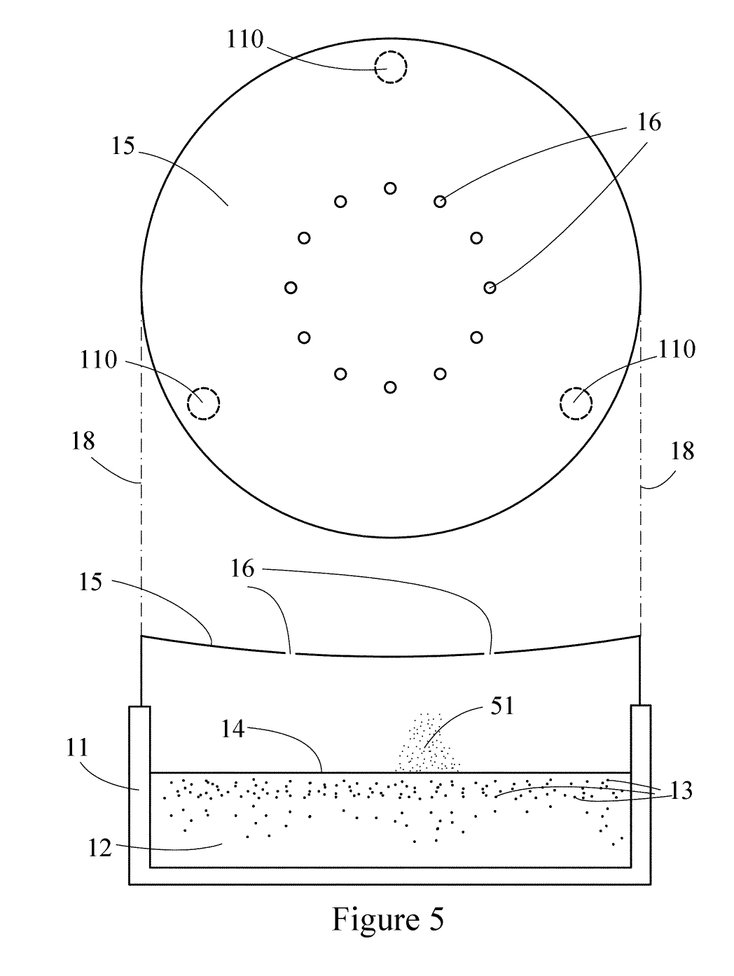

FIG. 5 illustrates a fifth preferred embodiment of the invention, which poisons mosquitos, using a substance which kills mosquitos, introduced into the stagnant, stationary pool of water 12. The preferred poison 51 is Bacillus thuringiensis israelensis (Bti), which is a commercially-produced bacteria, sold in pellet and powder form, used in the prior art to kill mosquitos without harmful side effects for humans, small animals and other non-target species. This poison 51 comprising Bti or equivalent, is simply distributed into the stagnant stationary pool of water 12 as illustrated. Once in the water, this produces proteins that turn into toxins after the larvae eat it. The stagnant stationary pool of water 12 in this event, is simply a trap to draw the mosquitos toward the water with the poison 51. This embodiment also uses the water collector and debris shield 15 with the plurality of water apertures 16 reviewed in FIG. 1, for the same reasons.

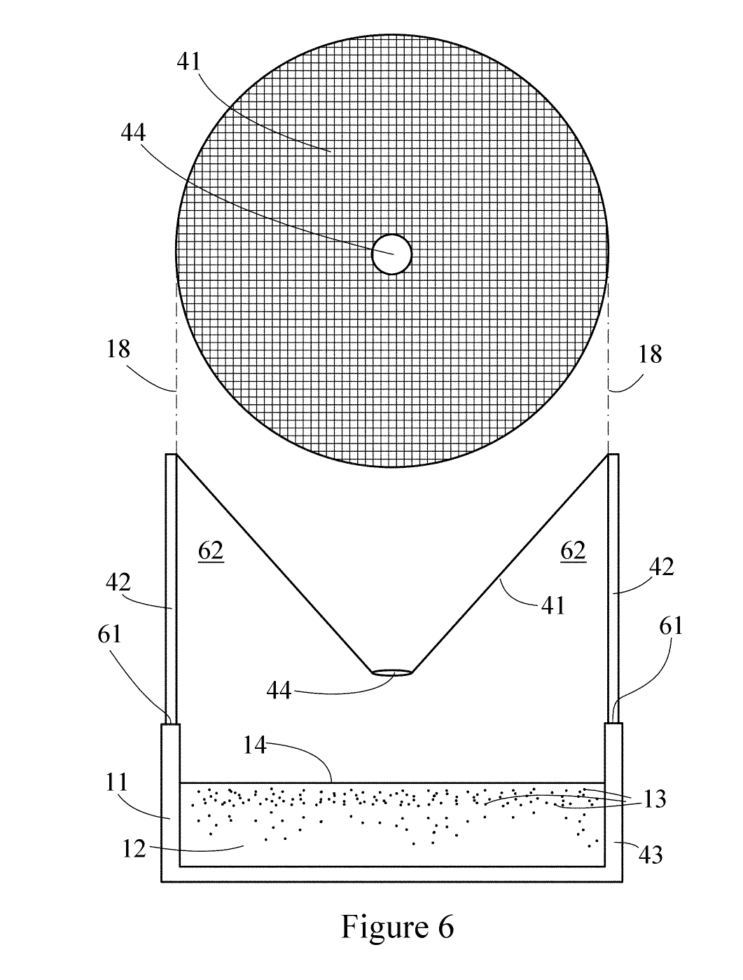

FIG. 6 illustrates a sixth preferred embodiment of the invention, similar in many respects to the fourth preferred embodiment of FIG. 4. What renders this embodiment different from that of FIG. 4, is that the trapping screen 41 has a downward funnel profile seen in cross section toward the bottom part of FIG. 6, terminating in the female entry hole 44 at the bottom of the funnel. This funnel-shaped trapping screen 41 is attached to and supported by the same sort of light-transparent section 42 which was disclosed in FIG. 4, but this section 42 is now taller in height to provide circumferential support to the funnel-shaped screen 41 which inherently has an elevated perimeter. The entire upper assembly which includes the extended light-transparent section 42 and the screen 41 with its hole 44 is designed to securely mate 61 with the top circumferential perimeter of the larvae trap 11, using any of a range of suitable mating apparatuses available in the art. In sum, the screen 41 in this embodiment is a wide cone with a truncated apex, inverted.

This works similarly to the FIG. 4 embodiment, but now, the elevated area above the level of the female entry hole 44 provides additional space in which mosquitos that have hatched will remain trapped. Specifically, the larvae after hatching will not only try to migrate toward any light which enters because of the transparent section 42, but will also try to fly as high up as they can get. This will trap them in the upper, outer upper circumferential corners 62 beneath the screen 41, with little if any hope for them to every make their way down and toward the center to exit via the hole 44. In this way, once again, the larvae are killed. Although not shown in FIG. 6, this embodiment may also be used together with the water collector and debris shield 15 which has been previously described for the other embodiments.

The traps in all embodiments can be made light weight, inexpensive, easy to deploy, and simple to maintain. These Skeeter Eater™ devices can be placed just about everywhere: in woods, jungles, backyards, swamps, and anywhere else that mosquitos are a problem.

When a trap in accordance with the invention is initially deployed, the water first introduced may not be sufficiently stagnant to attract mosquitos. Therefore, it is recommended that a stagnant water culture be introduced to facilitate the initial stagnation of the water. Thereafter, the water should become and remains stagnant indefinitely. It is also preferred but not required, that a small amount of biodegradable material be added to the stagnant stationary pool of water 12 to add to the stagnation and provide feeder material for algae growth.

The knowledge possessed by someone of ordinary skill in the art at the time of this disclosure, including but not limited to the prior art disclosed with this application, is understood to be part and parcel of this disclosure and is implicitly incorporated by reference herein, even if in the interest of economy express statements about the specific knowledge understood to be possessed by someone of ordinary skill are omitted from this disclosure. While reference may be made in this disclosure to the invention comprising a combination of a plurality of elements, it is also understood that this invention is regarded to comprise combinations which omit or exclude one or more of such elements, even if this omission or exclusion of an element or elements is not expressly stated herein, unless it is expressly stated herein that an element is essential to applicant's combination and cannot be omitted. It is further understood that the related prior art may include elements from which this invention may be distinguished by negative claim limitations, even without any express statement of such negative limitations herein. It is to be understood, between the positive statements of applicant's invention expressly stated herein, and the prior art and knowledge of the prior art by those of ordinary skill which is incorporated herein even if not expressly reproduced here for reasons of economy, that any and all such negative claim limitations supported by the prior art are also considered to be within the scope of this disclosure and its associated claims, even absent any express statement herein about any particular negative claim limitations.

Finally, while only certain preferred features of the invention have been illustrated and described, many modifications, changes and substitutions will occur to those skilled in the art. It is, therefore, to be understood that the appended claims are intended to cover all such modifications and changes as fall within the true spirit of the invention.

I claim:

1. An apparatus for concentrating then killing mosquitos, comprising:
a mosquito larvae trap for containing a stagnant, stationary pool of water for luring female mosquitos;
a mosquito trapping screen in the shape of an inverted funnel comprising a fine mesh of apertures small enough to prevent mosquitos from passing therethrough, and comprising at least one female entry hole proximate its lower center inverted apex which female entry hole is large enough to allow passage by female mosquitos;
said mosquito trapping screen entirely covering a top portion of said mosquito larvae trap to bar entry to said stagnant, stationary pool of water other than by passing through said female entry hole;
said mosquito larvae trap further comprising a light-transparent section over at least a substantial portion of its upper perimeter; wherein:
female mosquitos lured to said stagnant, stationary pool of water can gain entry thereto through said female entry hole; and
baby mosquitos hatched from eggs laid by female mosquitos in said stagnant, stationary pool of water, lured by ambient light passing through said light-transparent section of said perimeter of said mosquito larvae trap, and also attempting to fly upwards, are unable to escape and thereby remain trapped beneath the outer upper circumferential section of said screen until they die.

2. The apparatus of claim 1, further comprising a water collector and debris shield situated above said mosquito larvae trap for shielding said mosquito larvae trap from falling debris and for collecting rainwater and funneling it into said trap.

3. The apparatus of claim 1, further comprising an electrically-powered light source for providing said ambient light during non-daylight hours.

4. The apparatus of claim 3, further comprising an actuator for actuating and de-actuating said electrically-powered light source, said actuator selected from the actuator group consisting of: a timer; and a light-responsive detector.

5. The apparatus of claim 1, further comprising a water reservoir for maintaining a substantially constant level of said stagnant, stationary pool of water in said mosquito larvae trap.

6. The apparatus of claim 1, further comprising at least one additive for attracting mosquitos to said trap.

7. The apparatus of claim 1, further comprising at least one additive for facilitating the stagnation of said water in said trap.

8. A method for concentrating then killing mosquitos, comprising:
luring female mosquitos using a stagnant, stationary pool of water contained in a mosquito larvae trap;
barring entry to said stagnant, stationary pool of water other than by passing through at least one female entry hole proximate a lower center inverted apex of a mosquito trapping screen in the shape of an inverted funnel entirely covering a top portion of said mosquito larvae trap;
said mosquito trapping screen comprising a fine mesh of apertures small enough to prevent mosquitos from passing therethrough;
said at least one female entry hole being large enough to allow passage by female mosquitos;
providing a light-transparent section over at least a substantial portion of an upper perimeter of said mosquito larvae trap;
luring female mosquitos to said stagnant, stationary pool of water and enabling them to gain entry thereto through said female entry hole, using said stagnant, stationary pool of water; and
luring baby mosquitos hatched from eggs laid by female mosquitos in said stagnant, stationary pool of water to said light-transparent section of said perimeter of said mosquito larvae trap using ambient light passing through; wherein:
said baby mosquitos, lured by the light and also attempting to fly upwards are unable to escape and thereby remain trapped beneath the outer upper circumferential section of said screen until they die.

9. The method of claim 8, further comprising shielding said mosquito larvae trap from falling debris and collecting rainwater and funneling it into said trap, using a water collector and debris shield situated above said mosquito larvae trap.

10. The method of claim 8, further comprising providing said ambient light during non-daylight hours using an electrically-powered light source.

11. The method of claim 10, further comprising actuating and de-actuating said electrically-powered light source, using an actuator selected from the actuator group consisting of: a timer; and a light-responsive detector.

12. The method of claim 8, further comprising maintaining a substantially constant level of said stagnant, stationary pool of water in said mosquito larvae trap, using a water reservoir interconnected with said stagnant, stationary pool of water.

13. The method of claim 8, further comprising attracting mosquitos to said trap using at least one additive therefor.

14. The method of claim 8, further comprising facilitating the stagnation of said water in said trap using at least one additive therefor.
